(19) United States
(12) Patent Application Publication
(10) Pub. No.: US 2011/0239195 A1
(43) Pub. Date: Sep. 29, 2011

(54) DEPENDENCE-BASED SOFTWARE BUILDS

(75) Inventors: Zheng Lin, Issaquah, WA (US); Michael L. Rowand, JR., Redmond, WA (US); Jonathan M. Class, Snohomish, WA (US); Kiran B. Doreswamy, Sammamish, WA (US); Om K. Sharma, Woodinville, WA (US)

(73) Assignee: MICROSOFT CORPORATION, Redmond, WA (US)

(21) Appl. No.: 12/732,100

(22) Filed: Mar. 25, 2010

(51) Int. Cl. G06F 9/44

(52) U.S. Cl. 717/126

(57) ABSTRACT

Dependence-based software builds are described. In embodiments, authored source code is received as inputs to a computer device to develop a buildable unit of a software build project. The software build project includes multiple buildable units that can be allocated for independent development among multiple developers, such as at computer devices local to each developer. At the computer device, dependent buildable units are identified that have a dependency relationship with the buildable unit for execution. The authored source code of the buildable unit is then validated to determine that the buildable unit executes with the dependent buildable units for error-free execution before the buildable unit is subsequently provided to a software build service that compiles the multiple buildable units to generate the software build project.

### BACKGROUND

Large-scale software development projects are complicated to manage and build, and many developers, working independently, author source code that is later compiled to develop a software application, such as an operating system. An extensive software application may include thousands, or even hundreds of thousands, of source code files, all authored by different developers, yet having any number of inter-related dependencies. The developers can face lengthy and complex challenges when compiling the thousands of source code files, particularly when changes are made to one source code file that may affect any number of other source code files and/or the dependencies. The impact of source code changes to other source code files is often difficult to determine and may cause unknown conditions and/or unexpected results and failures, such as timing breaks. The source code file dependencies typically dictate the sequence by which a large-scale software development project is built. However, these dependencies are not always apparent or even easily ascertainable, and are difficult to manage.

### SUMMARY

This summary is provided to introduce simplified concepts of dependence-based software builds that are further described below in the Detailed Description. This summary is not intended to identify essential features of the claimed subject matter, nor is it intended for use in determining the scope of the claimed subject matter.

Dependence-based software builds are described. In embodiments, authored source code is received as inputs to a computer device to develop a buildable unit of a software build project. The software build project includes multiple buildable units that can be allocated for independent development among multiple developers, such as at computer devices local to each developer. At the computer device, dependent buildable units are identified that have a dependency relationship with the buildable unit for execution. The authored source code of the buildable unit is then validated to determine that the buildable unit executes with the dependent buildable units for error-free execution before the buildable unit is subsequently provided to a software build service that compiles the multiple buildable units to generate the software build project.

In other embodiments, the dependent buildable units are received from the software build service that links and compiles the software build project. The dependent buildable units can be identified as child buildable units that are dependent on the buildable unit for execution, and/or as parent buildable units from which the buildable unit is dependent on for execution. The authored source code of the buildable unit is validated to execute with the child buildable units and/or the parent buildable units at the computer device before the buildable unit is subsequently provided to the software build service.

In other embodiments, source code metadata is generated at the computer devices that are local to each developer. The source code metadata identifies each instance of a file access as defined in the authored source code of a buildable unit. The source code metadata from each computer device is provided to the software build service that generates a relational graph of the buildable units that are associated based on the file accesses listed in the source code metadata. A dependency hierarchy can then be derived from the relational graph, and the dependency hierarchy identifies dependencies between the buildable units of the software build project.

### BRIEF DESCRIPTION OF THE DRAWINGS

Embodiments of dependence-based software builds are described with reference to the following drawings. The same numbers are used throughout the drawings to reference like features and components:

FIG. 1 illustrates various examples of a buildable unit in accordance with one or more embodiments of dependence-based software builds.

FIG. 2 illustrates an example of a software build system in which embodiments of dependence-based software builds can be implemented.

FIG. 3 illustrates another example of a software build system in which embodiments of dependence-based software builds can be implemented.

FIG. 4 illustrates an example architecture in accordance with one or more embodiments of dependence-based software builds.

FIG. 5 illustrates example method(s) of dependence-based software builds in accordance with one or more embodiments.

FIG. 6 illustrates additional example method(s) of dependence-based software builds in accordance with one or more embodiments.

FIG. 7 illustrates various components of an example device that can implement embodiments of dependence-based software builds.

### DETAILED DESCRIPTION

Embodiments of dependence-based software builds provide that dependencies between buildable units of a large-scale software build project can be determined from file access pattern analysis. A buildable unit of a software build project may include files, sub-files, a directory and its contents (e.g., files and sub-files), a group of directories and the contents, and/or any combination thereof A developer at an independent computer device can author source code for a buildable unit of the software build project, integrate only the dependent buildable units that are dependent on or depend from the buildable unit, and validate the source code and/or changes to the source code locally at the developer computer device. A buildable unit that has been validated can then be provided to a software build service. The dependencies between buildable units are utilized to enable robust synchronization to minimize timing-related build breaks, and developers can utilize the dependency information to assist in analysis and refactoring authored source code, and changes to source code files.

While features and concepts of the described systems and methods for dependence-based software builds can be implemented in any number of different environments, systems, and/or various configurations, embodiments of dependence-based software builds are described in the context of the following example systems and environments.

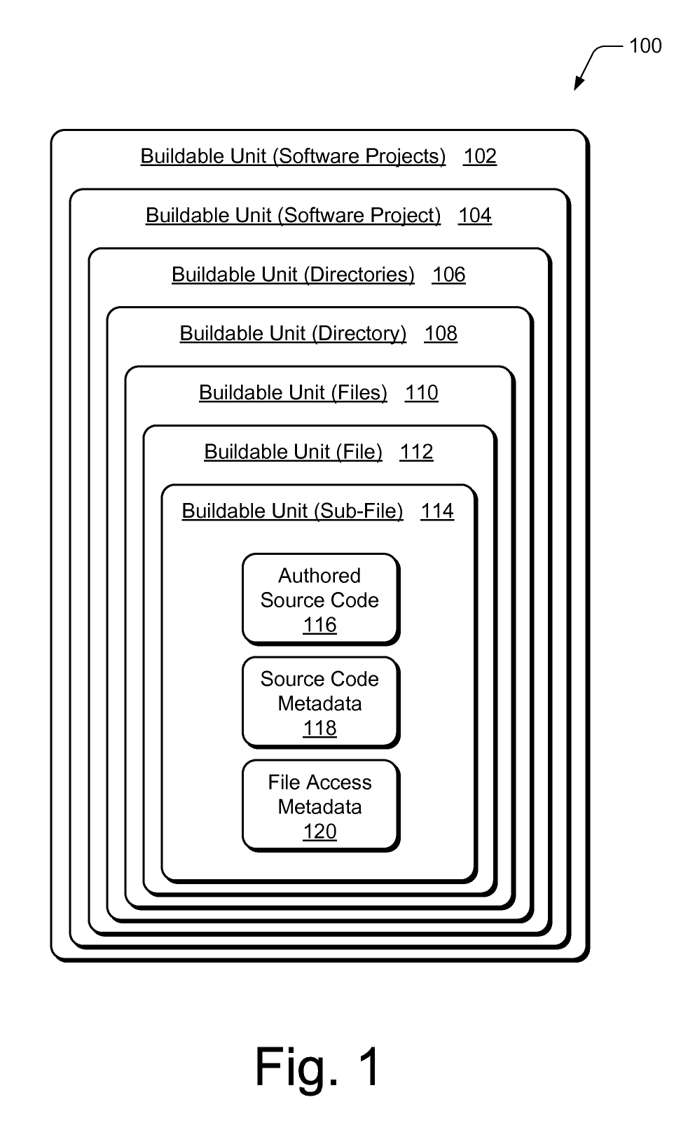

FIG. 1 illustrates various examples 100 of a buildable unit in accordance with one or more embodiments of dependence-based software builds. Any type of large-scale software development project may involve many developers working in parallel to generate buildable units of the project. As described herein, a buildable unit may be any data in the form of software projects 102, a software project 104, directories 106, a directory 108, files 110, a file 112, a sub-file 114, and/or any combination thereof Any of the buildable units may include contents, such as a directory 108 that includes files and/or sub-files, or a software project 104 that includes directories (e.g., of files and/or sub-files). Additionally, any of the buildable units can be implemented or developed to include authored source code 116, such as source code that is authored by a developer to generate a buildable unit.

Any of the buildable units may also include source code metadata 118 and/or file access metadata 120. When the source code 116 is authored, the source code metadata 118 is also generated and/or derived, which can include any type of information corresponding to the authored source code 116. The source code metadata 118 can include derived source code, such as intermediate input/output files that are generated and managed by a dependency system. The source code metadata 118 can also include the file access metadata 120 that identifies each instance of a file access for a particular buildable unit. In various embodiments, any of the buildable units may exist as files that are written to any type of data storage, such as a disc, storage media, and/or volatile RAM.

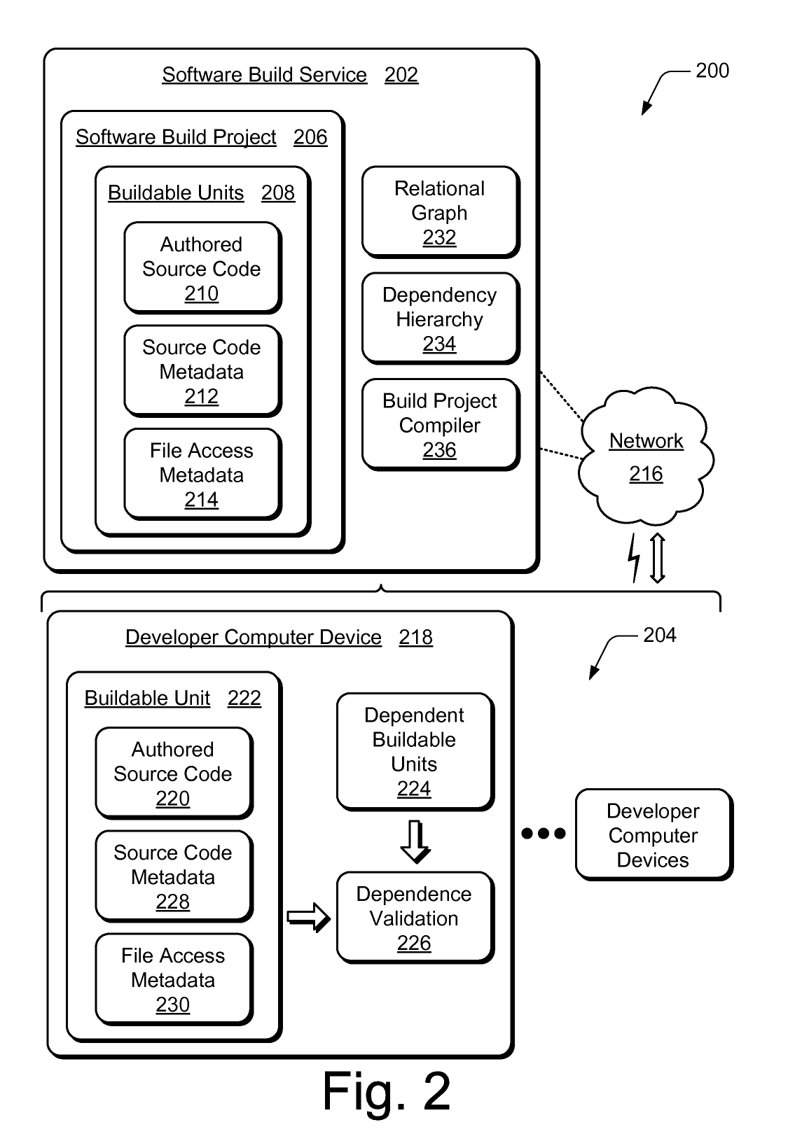

FIG. 2 illustrates an example of a software build system 200 in which various embodiments of dependence-based software builds can be implemented. The example system 200 includes a software build service 202 and multiple developer computer devices 204, such as computer devices local to each developer that may author source code and contribute buildable units to a large-scale software build project. The software build service 202 includes a software build project 206, such as any type of large-scale software development project that can involve many developers working in parallel to generate buildable units 208 of the software build project. As described with reference to FIG. 1, the software build project 206 may also be represented and/or implemented as a buildable unit (e.g., buildable unit 104). The multiple buildable units 208 can be allocated for independent development among multiple developers, and then provided or uploaded to the software build service 202 that generates the software build project 206 from the buildable units. Any one or combination of the buildable units 208 may be represented and/or implemented as any of the various examples of buildable units described with reference to FIG. 1. Additionally, any of the buildable units 208 may include authored source code 210, source code metadata 212, and/or file access metadata 214.

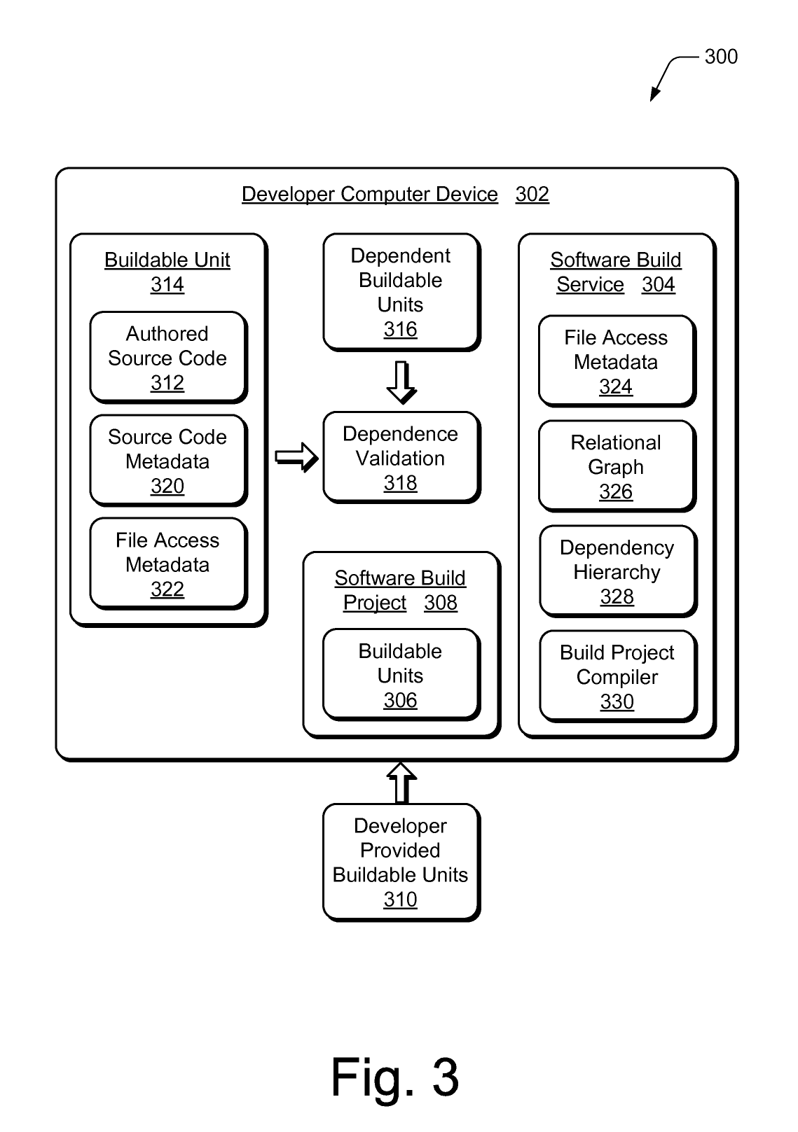

In an alternate implementation of a software build system, a single developer computer device may include the software build service 202 as described with reference to the example software build system shown in FIG. 3. The buildable units 208 of the software build project 206 may then be generated by one or many developers that contribute buildable units for the software build project on the single developer computer device. As source code and source code metadata is developed and changed, the source code and metadata can be reliably exchanged between disparate computing systems and devices that may or may not be networked for data communication. As described above, a buildable unit 208 of a software build project may include files, sub-files, a directory and its contents (e.g., files and sub-files), a group of directories and the contents, and/or any combination thereof Dependencies between the various buildable units 208 of the software build project can be determined from file access pattern analysis implemented by the software build service 202.

The software build service 202 may be implemented as a distributed computing system of one or more computer devices, and/or is representative of a central computing device. The central computing device may be local to the developer computer devices 204, or may be located remotely from the computer devices. The software build service and the multiple developer computer devices 204 can communicate data via a network 216, such as an IP-based network, a wireless network, and/or other type of network that facilitates data communication. The network 216 can be implemented using any type of network topology and/or communication protocol, and can be represented or otherwise implemented as a combination of two or more networks.

An example developer computer device 218 represents just one of the many developers that authors source code 220 as a buildable unit 222 of the software build project 206. The computer device 218 receives the authored source code 220 as inputs to the computer device, and the buildable unit 222 of the software build project 206 is developed. The developer computer device 218 also receives dependent buildable units 224 from the software build service 202. The dependent buildable units 224 are identified as buildable units that have a dependency relationship with the buildable unit 222 for execution. For example, the dependent buildable units 224 may be one or more child buildable units that are dependent on the buildable unit 222 for execution. Alternatively or in addition, the dependent buildable units 224 may be one or more parent buildable units from which the buildable unit 222 is dependent on for execution.

The developer computer device 218 may also include a dependence validation application 226 used to validate that the authored source code 220 of the buildable unit 222 executes with the dependent buildable units 224 for error-free execution before the buildable unit 222 is subsequently provided or uploaded to the software build service 202 and compiled into the software build project 206. Timing breaks that may be caused by the buildable unit 222 can also be resolved locally at the computer device 218 when the authored source code 220 is validated before the buildable unit is provided to the software build service. Accordingly, a developer can author source code for a buildable unit, integrate only the dependent buildable units that are dependent on or depend from the buildable unit, and validate the source code and/or changes to the source code locally at the developer computer device 218 before the buildable unit is provided or uploaded for integration with the software build project.

When the source code 220 is authored at the developer computer device 218, source code metadata 228 is also generated and can include file access metadata 230 that identifies each instance of a file access for the particular buildable unit 222. All of the file accesses developed in the authored source code 220 can be logged, such as in a trace file. The source code metadata 228 is then provided or uploaded from the developer computer device 218 to the software build service 202 and is saved as the file access metadata 214 when source code metadata is received from one or more of the developer computer devices 204.

The software build service 202 can then generate a relational graph 232 of the buildable units 208 that are associated based on the file accesses listed in the file access metadata 214. The relational graph 232 is a representation of the software build project 206. Additionally, the software build service 202 can generate a dependency hierarchy 234 from the relational graph 232, and the dependency hierarchy 234 identifies dependencies between the buildable units 208 of the software build project. In various embodiments, the software build service 202 represents any techniques that may be implemented to support running a number ‘n’ invocations of the build project across a number ‘m’ build types and merging all of the ‘n:m’ permutations into a single large relational graph of the buildable units. The relational graph 232 from which the dependency hierarchy 234 is generated evolves as the multiple buildable units 208 are authored and received from the various developer computer devices 204, along with corresponding source code metadata for each buildable unit. The software build service 202 may also implement a build project compiler 236 to link and compile the software build project 206 based on the dependency hierarchy of the buildable units 208.

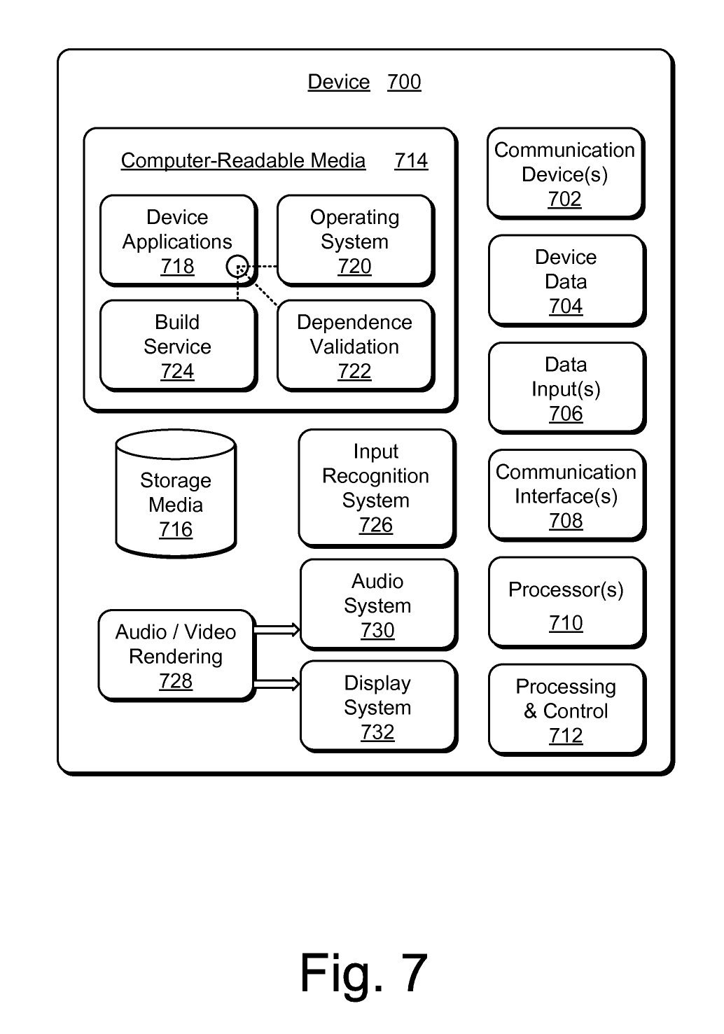

In implementations of dependence-based software builds, the software build service 202 and the various components thereof represent computer-executable instructions that are executable by processors to implement the various embodiments and/or features described herein. In addition, the software build service 202 (e.g., implemented as a distributed computing system or central computing device), as well as the developer computer devices 204, can be implemented with any number and combination of differing components as further described with reference to the example device shown in FIG. 7.

FIG. 3 illustrates another example of a software build system 300 in which various embodiments of dependence-based software builds can be implemented. The example system 300 includes a developer computer device 302 that is implemented with a software build service 304. A developer can author source code and generate buildable units 306 for a large-scale software build project 308 at the developer computer device 302. Optionally, for the large-scale software build project 308, other developers working in parallel can generate and provide other buildable units 310 for the software build project. As described with reference to FIG. 1, the software build project 308 may also be represented and/or implemented as a buildable unit (e.g., buildable unit 104). Additionally, any one or combination of the buildable units 306 of the software build project, and the other developer provided buildable units 310, may be represented and/or implemented as any of the various examples of buildable units described with reference to FIG. 1.

A developer at the developer computer device 302 can author source code 312 as a buildable unit 314 of the software build project 308. The computer device 302 receives the authored source code 312 as inputs to the computer device, and the buildable unit 314 of the software build project 308 is developed. Dependent buildable units 316 are identified as buildable units that have a dependency relationship with the buildable unit 314 for execution. For example, the dependent buildable units 316 may be one or more child buildable units that are dependent on the buildable unit 314 for execution. Alternatively or in addition, the dependent buildable units 316 may be one or more parent buildable units from which the buildable unit 314 is dependent on for execution.

The developer computer device 302 may also include a dependence validation application 318 used to validate that the authored source code 312 of the buildable unit 314 executes with the dependent buildable units 316 for error-free execution before the buildable unit 314 is subsequently provided to the software build service 304 and compiled into the software build project 308. Timing breaks that may be caused by the buildable unit 314 can also be resolved locally at the computer device 302 when the authored source code 312 is validated before the buildable unit is provided to the software build service. Accordingly, a developer can author source code for a buildable unit, integrate only the dependent buildable units that are dependent on or depend from the buildable unit, and validate the source code and/or changes to the source code locally at the developer computer device 302 before the buildable unit is integrated with the software build project.

When the source code 312 is authored at the developer computer device 302, source code metadata 320 is also generated and can include file access metadata 322 that identifies each instance of a file access for the particular buildable unit 314. All of the file accesses developed in the authored source code 312 can be logged, such as in a trace file. The source code metadata 320 is then provided to the software build service 304 and is saved as file access metadata 324, which may include other source code metadata received with the other developer provided buildable units 310.

The software build service 304 can then generate a relational graph 326 of the buildable units 306 that are associated based on the file accesses listed in the file access metadata 324. The relational graph 326 is a representation of the software build project 308. Additionally, the software build service 304 can generate a dependency hierarchy 328 from the relational graph 326, and the dependency hierarchy 328 identifies dependencies between the buildable units 306 of the software build project. In various embodiments, the software build service 304 represents any techniques that may be implemented to support running a number ‘n’ invocations of the build project across a number ‘m’ build types and merging all of the ‘n:m’ permutations into a single large relational graph of the buildable units. The relational graph 326 from which the dependency hierarchy 328 is generated evolves as the multiple buildable units 306 are authored and the corresponding source code metadata is generated for each buildable unit. The software build service 304 may also implement a build project compiler 330 to link and compile the software build project 308 based on the dependency hierarchy of the buildable units 306.

In implementations of dependence-based software builds, the software build service 304 and the various components of the developer computer device 302 represent computer-executable instructions that are executable by processors to implement the various embodiments and/or features described herein. In addition, the software build service 304, as well as the developer computer device 302, can be implemented with any number and combination of differing components as further described with reference to the example device shown in FIG. 7.

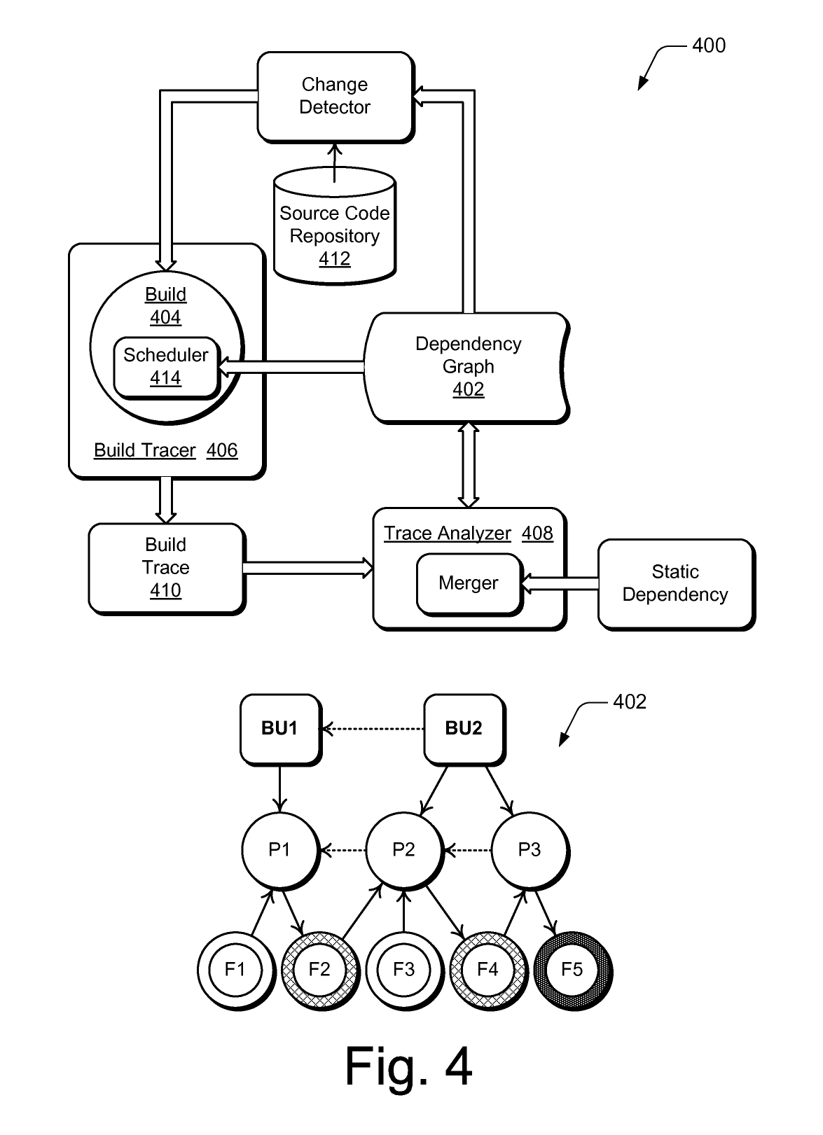

FIG. 4 illustrates an example architecture 400 in embodiments of dependence-based software builds, as well as an example of a dependency graph 402. The example architecture 400 can be implemented and utilized to identify the dependencies based on file access patterns (e.g., read, write, copy, delete), and to identify the associated processes in a build trace. In an implementation, any process that would consume an output file waits until the particular output file has been written by its producer process. This establishes a dependency between the producer process and the consumer process, and transitively to the respective buildable units where development is performed.

With this dependency information, a build 404 (e.g., a software build project) can be scheduled so that the identified dependencies are respected for subsequent builds (i.e., consumer buildable units are not scheduled until producer buildable units have all completed successfully). Any target buildable unit can then be built successfully by traversing its producer chain, rather than employing the possibly error-prone manual processes or with an ad-hoc script. All of the consumers of a given buildable unit can also be built, thus minimizing the risk of inadvertently providing or introducing a change which may break future instantiations of build 404. Furthermore, a detailed analysis of the build processes can be performed to evaluate whether a predefined set of software development policies are followed. Potentially unsafe operations can be intercepted at an early stage of development, rather than being discovered later in the product cycle, or potentially not recognized until after the final product has been distributed for use.

Conceptually, a build process to build a large-scale software project can be outlined as follows: a top level build processes starts; it reads and/or writes files; it generates a number of child processes; the child processes each read and/or write files, run other child processes, and then completes; and the top level build process finishes and is complete. The example architecture 400 includes a build tracer 406 that monitors the top level build processes as it executes. The build tracer 406 intercepts process and file system activities, and records them into a trace file. An overall build process (i.e., the build 404) may intensively use CPU time, as well as I/O bandwidth and memory. Accordingly, the build tracing components (e.g., trace monitor and logging) are implemented with minimal disruption to the build process in order to avoid significantly degrading the build performance.

The example architecture 400 also includes a trace analyzer 408 that is implemented to obtain data from a build trace 410, such as the process tree rooted by the top level build process with an edge connecting a process to its parent process, and additional information about each process (e.g., PID, command line, directory) and file operations (e.g., file name, access mode, status). In an implementation, the build dependencies can be determined as follows: associate each process with the set of files it reads; associate each process with the set of files it writes to; and if a first process reads a file which is written by a second process, create a dependency edge to the second process. A first buildable unit is identified as depending on a second buildable unit if there is a child process associated with the first buildable unit which has a dependency edge to a child process associated with the second buildable unit.

The dependency graph 402 is a simplified example to show a resultant dependency between two buildable units, BU1 and BU2. The two buildable units are associated with various processes P1, P2, and P3. Each process is associated with a set of files, such as input files F1 and F3, an output file F5, and intermediate files F2 and F4. The dependency relationships are denoted by the dashed arrows. For example, process P3 depends on process P2 through file F4, and process P2 depends on process P1 through file F2. Accordingly, buildable unit BU2 has dependency on buildable unit BU1.

In embodiments, a dependency analysis can be based on some simplifying assumptions. For example, the build processes are controlled through command line parameters, and are not dependent on environment variables or registry settings. Additionally, each process is assumed to potentially read a set of input files, and/or write a set of output files. All of the files that are read by a process are considered to be inputs to all of the files written (i.e., the outputs). This is true for the vast majority of processes that run during a build.

As described with reference to FIGS. 2 and 3, build verification can be deployed to individual developers that author source code for buildable units of a software build project. Local build verification at a developer computer device (e.g., at source code repository 412) can detect build problems and coding errors at an earliest possible development phase so that they can be corrected before impacting other developers and the overall project. Build verification can also improve developer productivity, by preventing or assisting the analysis of build breaks. The build trace 410 is available at the end of each build invocation, so that various types of verification can be performed from the build trace according to the policies defined for the build project 404.

With the dependency graph 402 determined, the buildable units can be scheduled in partial order to satisfy the dependency relationships. Synchronization is ingrained in this design, so the build process does not have to rely on the error-prone manual specifications. The scheduling decisions are now solely at the discretion of a build scheduler 414, which can be implemented to utilize available I/O, processor resources, and optionally additional computing devices.

Embodiments of dependence-based software builds provide for a partial build in which a developer can reliably build any buildable unit or set of buildable units from scratch. With the knowledge of buildable unit dependencies, the build process 404 can transitively determine all the input dependencies for each of the dependents, and only a subset of the source project may be necessary to construct a buildable unit of the software build project.

Embodiments of dependence-based software builds also provide for an efficient and accurate incremental build. The incremental build capability enables rebuilding only the subset of the source project which is actually impacted by a change while producing accurate output. When a subset of the source project has previously been built on a given machine and some source code changes are made, subsequent rebuilds are fast and reliable. With the dependency graph 402 and a build trace 410, updates to a buildable unit can be detected and rebuilt. Further, partial build and incremental build scenarios can be combined together. For example, a developer can incrementally rebuild a component after project files have been modified and transitively rebuild all of its consumers incrementally.

Embodiments of dependence-based software builds also provide for source code discovery and analysis. Physical structure and relationships within the software project are exposed by the dependency graph, which can be used for code discovery or dependency analysis within or across buildable units. There are many useful applications for automated code discovery and analysis. For instance, software anomalies, such as cyclical dependencies, may also be detected from dependency analysis, providing an opportunity for architecture improvements. Another example is impact analysis. When a change has been made in the source project, the potential implications of such a change can be revealed. This information can then be used to drive risk analysis, test prioritization, and the like.

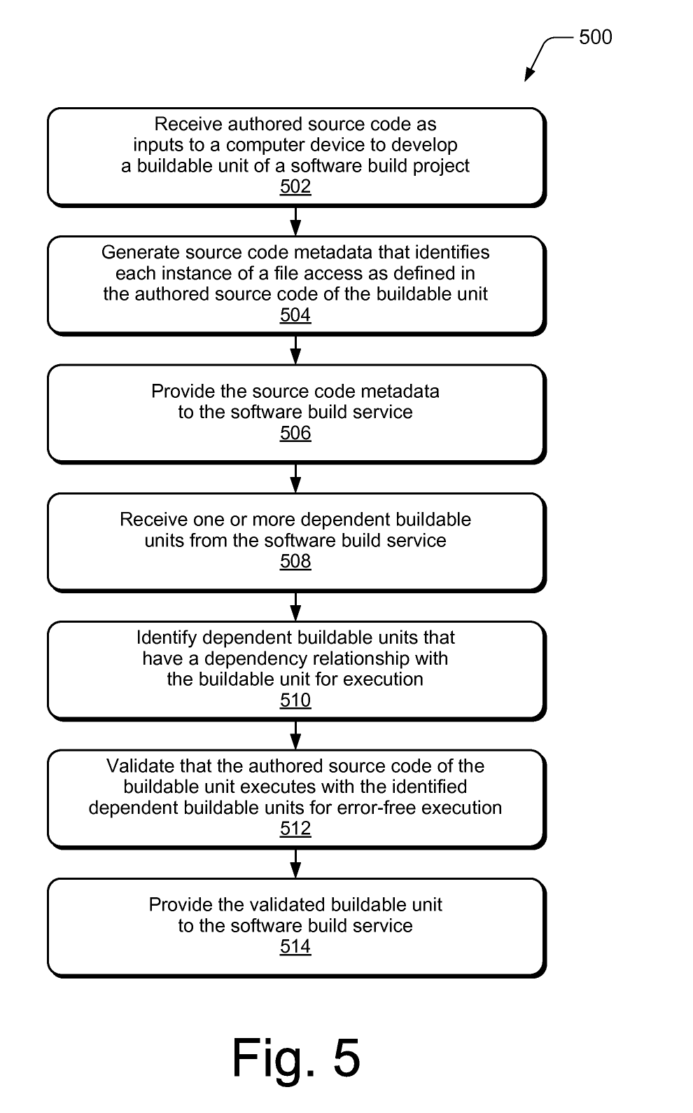

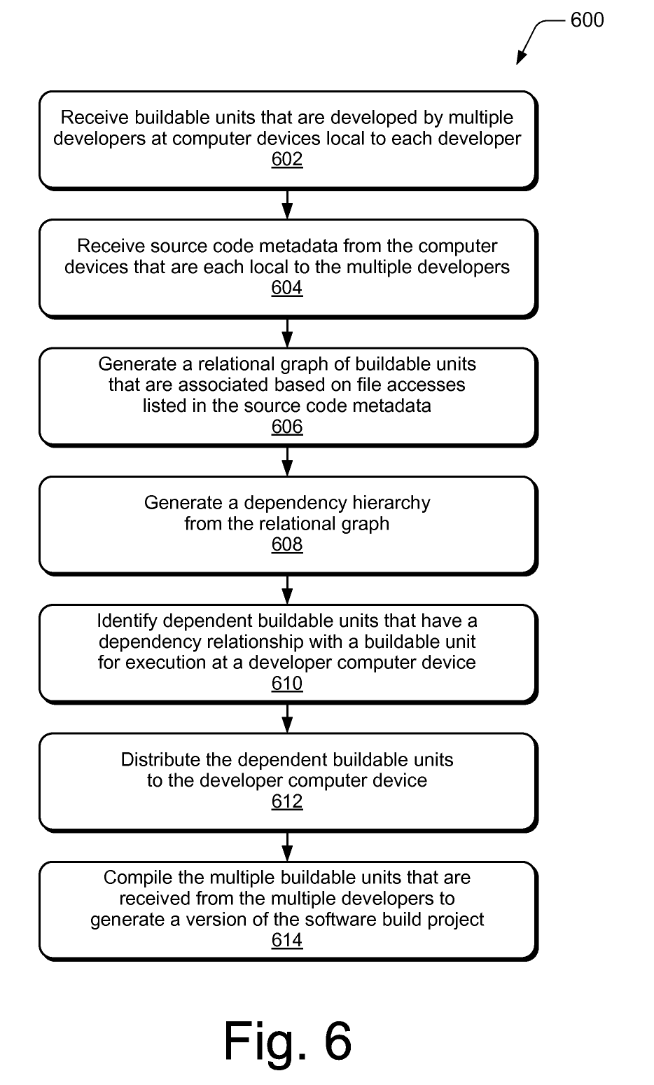

Example methods 500 and 600 are described with reference to respective FIGS. 5 and 6 in accordance with one or more embodiments of dependence-based software builds. Generally, any of the functions, methods, procedures, components, and modules described herein can be implemented using hardware, software, firmware, fixed logic circuitry, manual processing, or any combination thereof A software implementation represents program code that performs specified tasks when executed by a computer processor. The example methods may be described in the general context of computer-executable instructions, which can include software, applications, routines, programs, objects, components, data structures, procedures, modules, functions, and the like. The methods may also be practiced in a distributed computing environment by processing devices that are linked through a communication network. In a distributed computing environment, computer-executable instructions may be located in both local and remote computer storage and/or devices. Further, the features described herein are platform-independent and can be implemented on a variety of computing platforms having a variety of processors.

FIG. 5 illustrates example method(s) 500 of dependence-based software builds as described with reference to a developer computer device. The order in which the method blocks are described are not intended to be construed as a limitation, and any number of the described method blocks can be combined in any order to implement a method, or an alternate method.

At block 502, authored source code is received as inputs to a computer device to develop a buildable unit of a software build project. For example, the developer computer device 218 (FIG. 2) receives the authored source code 220 as inputs to the computer device to develop the buildable unit 222 of the software build project 206. The software build project includes the multiple buildable units 208 allocated for independent development among multiple developers, such as at the computer devices 204 that are local to each developer. The software build service 202 compiles the multiple buildable units 208 when received from the multiple developers to generate the software build project. In another example, the developer computer device 302 (FIG. 3) receives the authored source code 312 as inputs to the computer device to develop the buildable unit 314 of the software build project 308. A developer can author source code and generate the buildable units 306 for the large-scale software build project 308 at the developer computing device 302.

At block 504, source code metadata is generated that identifies each instance of a file access as defined in the authored source code of the buildable unit. For example, the source code metadata 228 is generated at computer device 218, and the source code metadata 228 includes the file access metadata 230 that identifies each instance of a file access. All of the file accesses developed in the authored source code 220 can be logged, such as in a trace file. In another example, the source code metadata 320 is generated at developer computer device 302 and includes the file access metadata 322 that identifies each instance of a file access for the particular buildable unit 314.

At block 506, the source code metadata is provided to the software build service. For example, the source code metadata 228 is provided from the developer computer device 218 to the software build service 202 and is saved as the file access metadata 214 when source code metadata is received from one or more of the developer computer devices 204. The software build service 202 then generates a relational graph 232 of the buildable units 208 that are associated based on the file accesses listed in the file access metadata 214 (e.g., the source code metadata 228 received from computer device 218). In another example, the source code metadata 320 is then provided to the software build service 304 and is saved as file access metadata 324, which may include other source code metadata received with the other developer provided buildable units 310.

The software build service 202 also generates a dependency hierarchy 234 from the relational graph. The dependency hierarchy identifies dependencies between the buildable units 208 of the software build project 206. The relational graph 232 from which the dependency hierarchy 234 is generated evolves as the multiple buildable units 208 are authored and received from the various developer computer devices 204, along with corresponding source code metadata for each buildable unit (e.g., received from the computer devices that are local to each of the multiple developers).

At block 508, one or more dependent buildable units are received from the software build service. For example, the computer device 218 receives the dependent buildable units 224 from the software build service 202 that identifies the dependent buildable units from the dependency hierarchy 234.

At block 510, dependent buildable units that have a dependency relationship with the buildable unit for execution are identified. For example, the dependent buildable units 224 at computer device 218 are identified as child buildable units that are dependent on the buildable unit 222 for execution and/or as parent buildable units from which the buildable unit 222 is dependent on for execution. In another example, dependent buildable units 316 are identified at the developer computer device 302 as buildable units that have a dependency relationship with the buildable unit 314 for execution.

At block 512, the authored source code of the buildable unit is validated to execute with the identified dependent buildable units for error-free execution. For example, the dependence validation application 226 validates that the authored source code 220 of the buildable unit 222 executes with the dependent buildable units 224 (e.g., the child buildable units and/or the parent buildable units) for error-free execution before the buildable unit 222 is provided to the software build service 202 and compiled into the software build project 206. Timing breaks that may be caused by the buildable unit 222 are also resolved locally at the computer device 218 when the authored source code 220 is validated before the buildable unit is provided to the software build service. In another example, the dependence validation application 318 at the developer computer device 302 is implemented to validate that the authored source code 312 of the buildable unit 314 executes with the dependent buildable units 316 for error-free execution before the buildable unit 314 is subsequently provided to the software build service 304 and compiled into the software build project 308.

At block 514, the validated buildable unit is provided to the software build service. For example, the developer computer device 218 provides the validated buildable unit to the software build service 202 that compiles the buildable unit 222 along with the buildable units 208 when received from the multiple developers to generate the software build project. In another example, a developer at the developer computer device 302 can author source code for a buildable unit, integrate only the dependent buildable units that are dependent on or depend from the buildable unit, and validate the source code and/or changes to the source code locally at the developer computer device 302 before the buildable unit is integrated with the software build project 308.

FIG. 6 illustrates example method(s) 600 of dependence-based software builds as described with reference to a software build service. The order in which the method blocks are described are not intended to be construed as a limitation, and any number of the described method blocks can be combined in any order to implement a method, or an alternate method.

At block 602, buildable units that are developed by multiple developers are received, such as from computer devices local to each developer. For example, the software build service 202 (FIG. 2) receives the multiple buildable units 208 of a software build project 206 from developer computer devices 204. The software build project 206 includes the multiple buildable units 208 allocated for independent development among the multiple developers, such as at the computer devices 204 local to each developer. Each buildable unit 208 is validated at a developer computer device 204 before being provided to the software build service. Alternatively, the software build service 304 at the developer computer device 302 (FIG. 3) generates the software build project 308 from the buildable units 306.

At block 604, source code metadata is received from the computer devices that are each local to the multiple developers. For example, the source code metadata 228 is received from the developer computer devices 204 and is saved as the file access metadata 214. The source code metadata 228 is generated at the developer computer devices 204 to identify each instance of a file access as defined in authored source code of a buildable unit. In another example, source code metadata 320 at the developer computer device 302 is generated and identifies each instance of a file access for a particular buildable unit 306. The source code metadata 320 is then saved as file access metadata 324, which may include other source code metadata received with the other developer provided buildable units 310.

At block 606, a relational graph of the buildable units that are associated based on the file accesses listed in the source code metadata is generated. For example, the software build service 202 generates the relational graph 232, which evolves as the multiple buildable units 208 are authored and received along with the corresponding source code metadata for each buildable unit. In another example, the software build service 304 at the developer computer device 302 generates the relational graph 326 of the buildable units 306 that are associated based on the file accesses listed in the file access metadata 324.

At block 608, a dependency hierarchy is generated from the relational graph. For example, the software build service 202 generates the dependency hierarchy 234 from the relational graph 232, and the dependency hierarchy identifies dependencies between the buildable units of the software build project 206. In another example, the software build service 304 at the developer computer device 302 generates the dependency hierarchy 328 from the relational graph 326, and the dependency hierarchy 328 identifies dependencies between the buildable units 306 of the software build project 308.

At block 610, dependent buildable units are identified that have a dependency relationship with a buildable unit for execution at a developer computer device where the buildable unit is developed. For example, the dependent buildable units 224 (i.e., dependent with respect to buildable unit 222 at computer device 218) are identified at the software build service 202 from the dependency hierarchy 234. The dependent buildable units 224 can be identified as child buildable units that are dependent on the buildable unit 222 for execution and/or as parent buildable units from which the buildable unit 222 is dependent on for execution. In another example, the dependent buildable units 316 at the developer computer device 302 are identified as buildable units that have a dependency relationship with the buildable unit 314 for execution. The dependent buildable units 316 can be identified as child buildable units that are dependent on the buildable unit 314 for execution and/or as parent buildable units from which the buildable unit 314 is dependent on for execution.

At block 612, the dependent buildable units are distributed to the developer computer device. For example, the software build service 202 distributes the dependent buildable units 224 to the developer computer device 218 for use when validating the buildable unit 222.

At block 614, the multiple buildable units that are received from the multiple developers are compiled to generate a version of the software build project. For example, the build project compiler 236 at the software build service 202 links and compiles the multiple buildable units 208 to generate a version of the software build project 206. In another example, the build project compiler 330 at the developer computer device 302 links and compiles the software build project 308 based on the dependency hierarchy of the buildable units 306.

FIG. 7 illustrates various components of an example device 700 that can be implemented as any type of computing device described with reference to FIGS. 2 and 3 to implement embodiments of dependence-based software builds. Device 700 may also be associated with a user (i.e., a person) and/or an entity that operates the device such that a device describes logical devices that include users, software, firmware, and/or a combination of devices.

Device 700 includes communication devices 702 that enable wired and/or wireless communication of device data 704 (e.g., received data, data that is being received, data scheduled for broadcast, data packets of the data, etc.). The device data 704 or other device content can include configuration settings of the device and/or data stored on the device. Device 700 includes one or more data inputs 706 via which any type of data, content, and/or inputs can be received, such as inputs to the device for authored source code of a buildable unit in a software build project.

Device 700 also includes communication interfaces 708 that can be implemented as any one or more of a serial and/or parallel interface, a wireless interface, any type of network interface, a modem, and as any other type of communication interface. The communication interfaces 708 provide a connection and/or communication links between device 700 and a communication network by which other electronic, computing, and communication devices communicate data with device 700.

Device 700 includes one or more processors 710 (e.g., any of microprocessors, controllers, and the like) which process various computer-executable instructions to control the operation of device 700 and to implement embodiments of dependence-based software builds. Alternatively or in addition, device 700 can be implemented with any one or combination of hardware, firmware, or fixed logic circuitry that is implemented in connection with processing and control circuits which are generally identified at 712. Although not shown, device 700 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 700 also includes computer-readable media 714, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 700 can also include a mass storage media device 716.

Computer-readable media 714 provides data storage mechanisms to store the device data 704, as well as various device applications 718 and any other types of information and/or data related to operational aspects of device 700. For example, an operating system 720 can be maintained as a computer application with the computer-readable media 714 and executed on processors 710. The device applications 718 can include a device manager (e.g., a control application, software application, signal processing and control module, code that is native to a particular device, a hardware abstraction layer for a particular device, etc.).

The device applications 718 also include any system components or modules to implement embodiments of dependence-based software builds. In this example, the device applications 718 can include a dependence validation application 722 and a build service 724. The dependence validation application 722 and a build service 724 are shown as software modules and/or computer applications.

Device 700 includes an input recognition system 726 implemented to recognize various inputs or combinations of inputs, such as touch, tap, and/or motion inputs. The input recognition system 726 may include any type of input detection features to distinguish the various types of inputs, such as sensors, light sensing pixels, touch sensors, cameras, and/or a natural user interface that interprets user interactions, gestures, inputs, and motions.

Device 700 also includes an audio and/or video rendering system 728 that generates and provides audio data to an audio system 730 and/or generates and provides display data to a display system 732. The audio system 730 and/or the display system 732 can include any devices that process, display, and/or otherwise render audio, display, and image data. Display data and audio signals can be communicated from device 700 to an audio device and/or to a display device via an RF (radio frequency) link, S-video link, composite video link, component video link, DVI (digital video interface), analog audio connection, or other similar communication link. In an embodiment, the audio system 730 and/or the display system 732 are implemented as external components to device 700. Alternatively, the audio system 730 and/or the display system 732 are implemented as integrated components of example device 700.

Although embodiments of dependence-based software builds have been described in language specific to features and/or methods, it is to be understood that the subject of the appended claims is not necessarily limited to the specific features or methods described. Rather, the specific features and methods are disclosed as example implementations of dependence-based software builds.

1. A software build system, comprising:
a software build project that includes multiple buildable units allocated for independent development among multiple developers, the multiple buildable units developed and provided to a software build service that is configured to generate the software build project from the multiple buildable units;
a computer device configured to:
receive authored source code to develop a buildable unit of the software build project;
identify one or more dependent buildable units that have a dependency relationship with the buildable unit for execution; and
validate that the authored source code of the buildable unit executes with the one or more dependent buildable units for error-free execution before the buildable unit is subsequently provided to the software build service and compiled into the software build project.

2. A software build system as recited in claim 1, wherein the computer device is further configured to receive the one or more dependent buildable units from the software build service, the one or more dependent buildable units identified from a dependency hierarchy that identifies dependencies between the buildable units of the software build project.

3. A software build system as recited in claim 2, wherein the computer device is further configured to:
identify one or more child buildable units that are dependent on the buildable unit for execution; and
validate that the authored source code of the buildable unit executes with the one or more child buildable units for the error-free execution before the buildable unit is subsequently provided to the software build service.

4. A software build system as recited in claim 2, wherein the computer device is further configured to:
identify one or more parent buildable units from which the buildable unit is dependent on for execution; and
validate that the authored source code of the buildable unit executes with the one or more parent buildable units for the error-free execution before the buildable unit is subsequently provided to the software build service.

5. A software build system as recited in claim 1, wherein the computer device is further configured to resolve a timing break caused by the buildable unit when the authored source code is validated before the buildable unit is subsequently provided to the software build service.

6. A software build system as recited in claim 1, wherein:
the computer device is further configured to generate source code metadata that identifies each instance of a file access as defined in the authored source code of the buildable unit; and
the source code metadata is provided to the software build service that generates a relational graph of the buildable units that are associated based on the file accesses listed in the source code metadata.

7. A software build system as recited in claim 6, wherein the software build service is further configured to generate a dependency hierarchy from the relational graph, the dependency hierarchy configured to identify dependencies between the buildable units of the software build project.

8. A software build system as recited in claim 7, wherein the relational graph from which the dependency hierarchy is generated evolves as the multiple buildable units are authored and provided along with corresponding source code metadata for each buildable unit.

9. A computer-implemented method, comprising:
receiving authored source code as inputs to a computer device to develop a buildable unit of a software build project that includes multiple buildable units allocated for independent development among multiple developers;
identifying one or more dependent buildable units that have a dependency relationship with the buildable unit for execution; and
validating that the authored source code of the buildable unit executes with the one or more dependent buildable units for error-free execution before the buildable unit is subsequently provided to a software build service that compiles the multiple buildable units to generate the software build project.

10. A computer-implemented method as recited in claim 9, further comprising receiving the one or more dependent buildable units from the software build service, the one or more dependent buildable units identified from a dependency hierarchy that identifies dependencies between the buildable units of the software build project.

11. A computer-implemented method as recited in claim 10, wherein the one or more dependent buildable units are identified as child buildable units that are dependent on the buildable unit for execution, and wherein the authored source code of the buildable unit is validated to execute with the child buildable units before the buildable unit is subsequently provided to the software build service.

12. A computer-implemented method as recited in claim 10, wherein the one or more dependent buildable units are identified as parent buildable units from which the buildable unit is dependent on for execution, and wherein the authored source code of the buildable unit is validated to execute with the parent buildable units before the buildable unit is subsequently provided to the software build service.

13. A computer-implemented method as recited in claim 9, further comprising resolving a timing break caused by the buildable unit when the authored source code is validated before the buildable unit is subsequently provided to the software build service.

14. A computer-implemented method as recited in claim 9, further comprising:
generating source code metadata that identifies each instance of a file access as defined in the authored source code of the buildable unit; and
providing the source code metadata to the software build service that generates a relational graph of the buildable units that are associated based on the file accesses listed in the source code metadata.

15. A computer-implemented method as recited in claim 14, wherein the software build service generates a dependency hierarchy from the relational graph, the dependency hierarchy configured to identify dependencies between the buildable units of the software build project.

16. A computer-implemented method as recited in claim 15, wherein the relational graph from which the dependency hierarchy is generated evolves as the multiple buildable units are authored and provided along with corresponding source code metadata for each buildable unit.

17. Computer-readable storage media comprising instructions that are executable and, responsive to executing the instructions, a computer device:
receives inputs as authored source code to develop a buildable unit of a software build project that includes multiple buildable units allocated for independent development among multiple developers;
identifies one or more dependent buildable units that have a dependency relationship with the buildable unit for execution;
validates that the authored source code of the buildable unit executes with the one or more dependent buildable units for error-free execution; and
provides the buildable unit to a software build service that compiles the multiple buildable units to generate the software build project.

18. Computer-readable storage media as recited in claim 17, further comprising additional instructions that are executable and, responsive to executing the additional instructions, the computer device resolves one or more timing breaks caused by the buildable unit when the authored source code is validated before the buildable unit is provided to the software build service.

19. Computer-readable storage media as recited in claim 17, further comprising additional instructions that are executable and, responsive to executing the additional instructions, the computer device receives the one or more dependent buildable units from the software build service, the one or more dependent buildable units identified from a dependency hierarchy that identifies dependencies between the buildable units of the software build project.

20. Computer-readable storage media as recited in claim 17, further comprising additional instructions that are executable and, responsive to executing the additional instructions, the computer device:
generates source code metadata that identifies each instance of a file access as defined in the authored source code of the buildable unit; and
provides the source code metadata to the software build service that generates a relational graph of the buildable units that are associated based on the file accesses listed in the source code metadata, and the software build service generates a dependency hierarchy from the relational graph, the dependency hierarchy identifying dependencies between the buildable units of the software build project.
